(19) United States
(12) Patent Application Publication
(10) Pub. No.: US 2022/0126146 A1
(43) Pub. Date: Apr. 28, 2022

(54) WIldfire Home Protection System

(71) Applicant: Robert Cerami, Costa Mesa, CA (US)

(72) Inventor: Robert Cerami, Costa Mesa, CA (US)

(21) Appl. No.: 17/333,656

(22) Filed: May 28, 2021

Related U.S. Application Data
(63) Continuation-in-part of application No. 17/081,489, filed on Oct. 27, 2020, now abandoned.

(51) Int. Cl. A62C 3/02; A62C 35/64; A62C 37/36

(52) U.S. Cl. CPC A62C 3/0264; A62C 37/04; A62C 35/64; A62C 3/0214

(57) ABSTRACT

A system and method for providing a wildfire home protection water blanket is disclosed. The system includes a plurality of water blanket distributors attached to and integrated into the fascia of a building, a water source and control components for connecting the plurality of water blanket distributors to a water source, and a water line connecting the plurality of water blanket distributors to the water valve, the water line receives water from the water valve upon receiving a user command. The plurality of water blanket distributors comprise an enclosure attached to and integrated into the fascia of the building under the eaves, a plurality of water distribution nozzles and a water line. The water source and control components comprise the water valve and a WIFI-enabled controller.

### CROSS-REFERENCE TO RELATED APPLICATION

This application claims priority to U.S. patent application Ser. No. 17/081,489, titled “WILDFIRE HOME PROTECTION SYSTEM” and filed on Oct. 27, 2020. The entire application is incorporated herein by reference in its entirety.

### TECHNICAL FIELD

This application relates in general to a system and method for providing a fire home protection aid, and more specifically, to a system and method for providing a wildfire home protection water blanket.

### BACKGROUND

The environmental impact of climate change has resulted in unprecedented disasters across the globe. In particular, wildfires have become increasingly more dangerous and common as rising temperatures result in larger swaths of dry brush and foliage. As humans continue to encroach on previously undeveloped areas, dwellings and buildings are being constructed in areas that are prone to seasonal wildfires. Consequently, during the dry season the risk of significant loss of buildings and danger to human life becomes more likely as the incidence of wildfires increase in frequency and ferocity.

During brush fires or wildfires, firefighters are often tasked with slowing the spread of the fire itself as it approaches residential or business areas. However, winds can often carry embers across substantial distances and start fires in areas that may not have been at immediate risk from the wildfire itself. This often results in homeowners or business owners attempting to fight the fire themselves using fire hoses or lawn sprinklers. However, this requires the constant use of the water hose by the homeowner or business owner which places the person in greater physical danger.

Fire sprinkler systems configured for use inside homes and buildings are known in the prior art. These sprinkler systems are typically configured for automatic operation and are activated once the ambient temperature in an interior environment reaches a maximum threshold value. Once activated, the automatic sprinklers emit a liquid, typically water, in a spray in the room or building. These types of fire suppression systems are not effective at combating wildfires or brush fires as they are dependent upon activation from high heat or smoke from an internal source. Also, these types of indoor systems do not protect the vulnerable spots on a home or building, such as the roof, under eaves, and external walls.

Prior attempts to direct water spray onto the roof or outer walls of a home or building have relied on a myriad of devices including temporarily mounting a plurality of rotating sprinklers on roofs as needed; U.S. Pat. No. 6,292,072 describes such a system. However, these systems still place the homeowner at risk as the proper usage of these sprinklers requires the operator to remain outside the home until the threat of wildfire has passed. Additionally, these sprinkler systems require the cumbersome installation of unsightly water spray heads around the perimeter of the building.

Therefore, a need exists for providing a wildfire home protection water blanket. The present invention attempts to address the limitations and deficiencies in prior solutions according to the principles and example embodiments disclosed herein.

### SUMMARY

In accordance with the present invention, the above and other problems are solved by providing a wildfire home protection water blanket according to the principles and example embodiments disclosed herein.

In one embodiment, the present invention is a system for providing a wildfire home protection water blanket. One or more embodiments of the present invention relate to a system for protecting a home or building from approaching wildfires. In one particular embodiment, the system is a device that is configured to blanket the home or building in a water blanket. In one or more embodiments, the device comprises a rectangular box connected to a water supply having a front face, a rear face, a left and right side, and a top portion, with a water hose positioned lengthwise inside the rectangular box, and water spray nozzles connected to the internal water hose that directs water spray onto the home or building. In particular, the water spray of the present invention is directed under eaves and walls of the building or home.

In another embodiment, the present invention is a system for providing a wildfire home protection water blanket. The system includes a plurality of water blanket distributors attached to and integrated into the fascia of a building, a water source and control components for connecting the plurality of water blanket distributors to a water source, and a water line connecting the plurality of water blanket distributors to the water valve, the water line receives water from the water valve upon receiving a user command. The plurality of water blanket distributors comprise an enclosure attached to and integrated into the fascia of the building under the eaves, a plurality of water distribution nozzles and a water line. The water source and control components comprise the water valve and a WIFI-enabled controller.

In another aspect of the present invention, the water distribution nozzles comprise a horizontal nozzle applying the wildfire home protection water blanket to outside walls of the building under the eaves.

In another aspect of the present invention, the water distribution nozzles further comprise a popup nozzle applying the wildfire home protection water blanket to a roof of the building.

In another aspect of the present invention, the system further comprises a user interface device electronically connected to the water source and control components for transmitting the user command to open and close the water valve.

In another aspect of the present invention, the water valve has a WIFI-enabled internal smart controller for receiving the user commands from the user interface device.

In another aspect of the present invention, the plurality of water blanket distributors physically abuts each other as positioned about the building enclosing the water line therein.

In another aspect of the present invention, the plurality of water blanket distributors are configures about all of the eaves and fascia of the building to direct the wildfire home protection water blanket onto all of the outside wall surfaces of the building.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides a wildfire home protection water blanket according to the present invention.

FIGS. 2a-b illustrate an example embodiment of a water blanket spray nozzle used to provide a wildfire home protection water blanket according to the present invention.

FIGS. 2c-2d illustrate an example embodiment of a water blanket distributor that may be used to provide a water blanket for one segment of the eaves of the home or building.

FIG. 3 illustrates another example embodiment of a system for providing a wildfire home protection water blanket according to the present invention.

FIG. 4 illustrates a computing system of software components for providing a wildfire home protection water blanket according to the present invention.

FIG. 5 illustrates a generalized schematic of a programmable processing system utilized as the various computing components described herein used to implement an embodiment of the present invention.

### DETAILED DESCRIPTION

This application relates in general to a system and method for providing a fire home protection aid, and more specifically, to a system and method for providing a wildfire home protection water blanket according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a media player, set-top box, smartphone, tablet, and/or web browser on any computing device.

The terms “homeowner” and “user” refer to an entity, e.g. a human, using a wildfire home protection water blanket system including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “A Wildfire Home Protection System.” Invention may be used interchangeably with water blanket.

The terms “communicate”, or “communication” refer to any component(s) connecting with any other component(s) in any combination for the purpose of the connected components to communicate and/or transfer data to and from any components and/or control any settings.

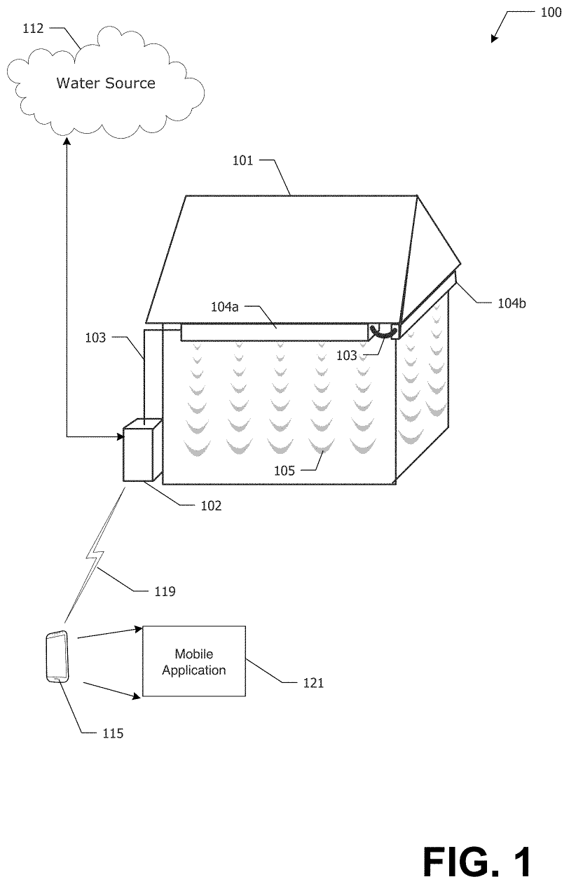

In general, the present disclosure relates to a system and method for providing a wildfire home protection water blanket. To better understand the present invention, FIG. 1 illustrates an example embodiment of a system that provides a wildfire home protection water blanket according to the present invention. The home protection water blanket system 100 is a water distribution system that is attached to a home or building 101 to generate a water blanket 105 about the outside surfaces of the home or building 101. A water source and control components 102 are coupled to a plurality of water blanket distributors 104a-d by a water line 103.

The water blanket distributors 104a-d are typically attached to a home or building 101 under the eaves and spray water upon an adjacent wall to run down its outside surface in the form of the water blanket 105. The water blanket distributors 104a-d are shown in FIG. 1 as being separate components connected by the water line 103 that run through each of the water blanket distributors 104a-d. In a preferred embodiment, each of the water blanket distributors 104a-d would abut against each other and/or be connected by a corner cap (not shown) to make the water line 103 not visible to the homeowner. The water blanket distributors 104a-d are intended to appear to be an integral part of the eaves. The water blanket distributors 104a-d are made up by a set of segments that are connected together as they are placed about the home or building 101 depending upon any particular shape of the eaves, roof peaks, and the like. The water blanket distributors 104a—are places about all sides of the home or building 101 in order to generate a water blanket 105 on all sides of the building 101.

This home protection water blanket system 100 protects the home or building 101 from an approaching wildfire by keeping the flammable surfaces covered by the water blanket 105. The home protection water blanket system 100 also may include rooftop water blanket distributors (not shown) if needed; however, many homes in areas that typically encounter wildfires include roofs made from non-flammable material such as clay or stone tiles, metal panels, and other non-flammable materials. For these homes or buildings 101, protecting the walls 101 may be sufficient.

The water source and control components 102 connect a water source 112 to the water line 103 to provide the water to generate the water blanket 105. The water source may include one or more of the following: municipal water supplies, local wells, nearby bodies of water, local water towers, and related water sources. The water source 112 may provide a pressurized flow of water using gravity from the water source 112 to the home or building 101 to generate the water pressure. The water source 112 also may provide a pressurized flow of water using a pump or similar mechanical device.

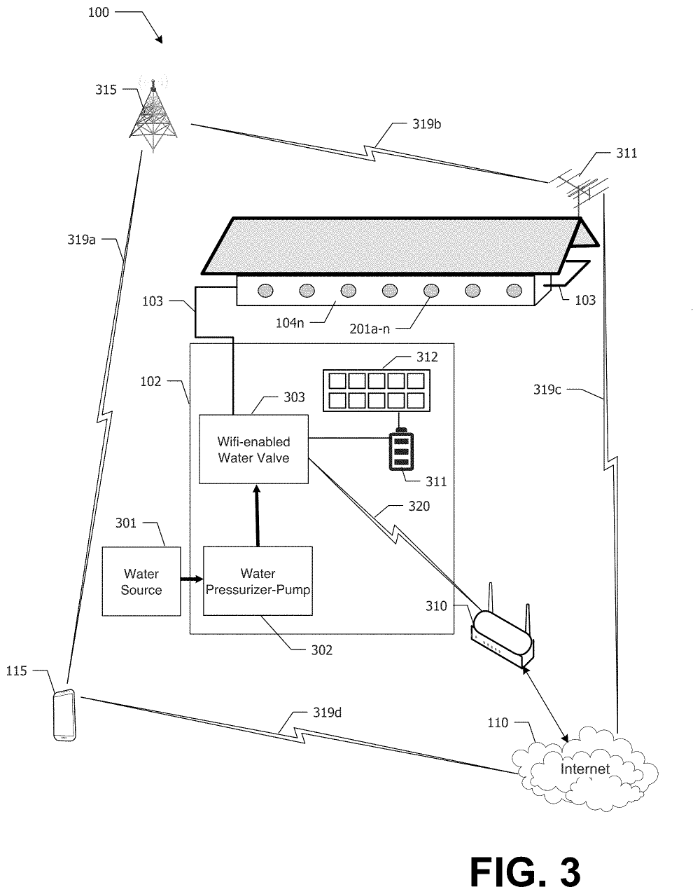

The water source and control components 102 also include a WIFI-enables control valve 303 as show in FIG. 3 to operate controls of the home protection water blanket system 100. The WIFI-enables control valve 303 may communicate with a user interface device 115 such as a mobile phone, tablet, and other mobile computing device to receive commands from a homeowner regarding the operation of the home protection water blanket system 100. The homeowner may send a command from the user interface device 115 to the WIFI-enables control valve 303 to activate the home protection water blanket system 100 and thus generate the water blanket 105 on the home or building 101.

The user interface device 115 and the WIFI-enables control valve 303 may communicate using wireless communications technology including a wireless connection 119 in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, or 6 GHz bands. Additionally, the wireless connection I 19 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. The connection 119 alternatively also can also be implemented using a fixed wireless connection that operates in accordance with, but is not limited to, 3rd Generation Partnership Project (3GPP) Long Term Evolution (LTE) or 5G cellular protocols.

The user interface device 115 may contain a mobile application 121 that may execute on programmable computing devices acting as the user interface device 115. The mobile application 121 can provide the homeowner with operating status of the home protection water blanket system 100, send commands to the WIFI-enables control valve 303, and receive images of the home or building 101 from cameras and video sources (not shown) about the home or building IO1. Using the images received from the control device 111 to the user interface device 115, the homeowner may determine when the home protection water blanket system 100 should be activated to best utilize any available water from the water source 112 before it is exhausted.

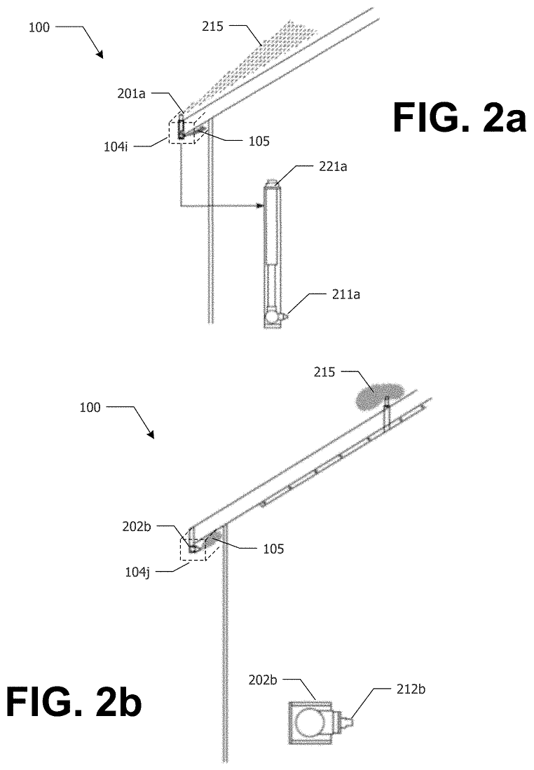

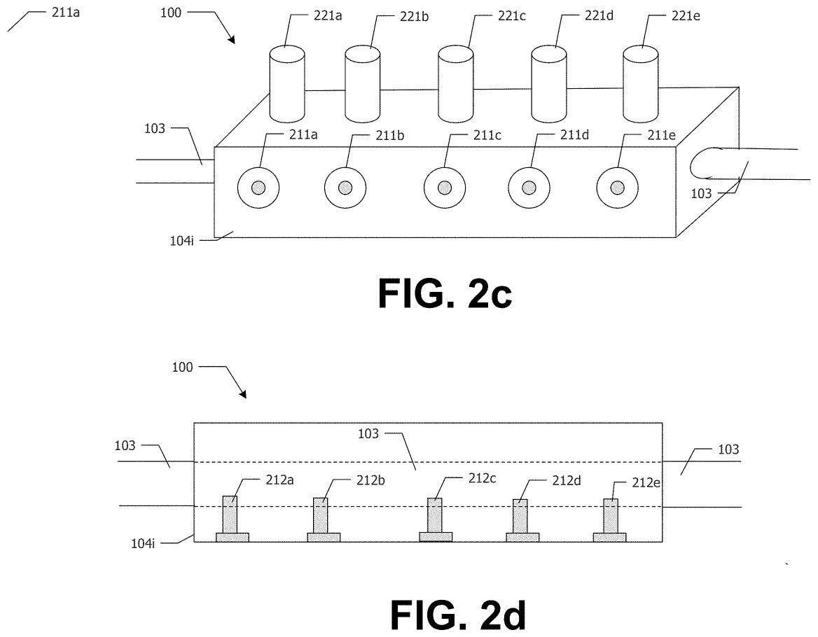

Each of the water blanket distributors I 04a-d may be connected in a series or in parallel to the water source and control components I 02 by the water line I 03. When the water source and control components 102 activate the home protection water blanket system I00, water from the water source 112 is permitted to flow into the water line 103 to the water blanket distributors 104a-d that contain water distribution nozzles 201a-b as shown in more detail in FIGS. 2a-b. Typically, the water distribution nozzles 201a-b are always open devices that will spray water upon the home or building 101 to generate the water blanket 105. The water distribution nozzles 201a-b are contained within a housing 202a-n that is attached to each eave on the home or building 101 with the water distribution nozzles 201a-b directing water toward the home building 101. When the water source and control components 102 activate the home protection water blanket system 100 to permit water from the water source 112 to flow into the water line 103, the water blanket 105 is generated as pressurized water will flow to the water distribution nozzles 201a-b and onto the home building 101.

FIGS. 2a-b illustrate an example embodiment of a water blanket spray nozzle used to provide a wildfire home protection water blanket according to the present invention. Two different types of nozzles are shown in FIGS. 2a-b, each containing an output nozzle 211a-b to the water line 103. The output nozzle 211a-b typically is configured at installation to provide a water pattern to generate the water blanket 105 over the entire outside walls of the home or building 101. FIG. 2a shows an output nozzle 201a that includes a horizontal nozzle 211a that sprays water under the eaves and onto the walls of the building. FIG. 2a also shows pop-up nozzles 212a that be used to provide a water blanket 215 for the roofing services where needed. In contrast, FIG. 2b shows a nozzle 202b having an output nozzle 221b that only directs the water blanket 105 spray onto the walls of the home or building 101.

FIGS. 2c and 2d show the water blanket distributor 104i that may be used to provide a water blanket 105 for one segment of the eaves of the home or building 101. FIG. 2c shows a single water blanket distributor 104i having a set of horizontal nozzles 211a-e along one side and a set of pop-up nozzles 212a-e that generates a water blanket onto the roofing surfaces 215. Each of these nozzles 201a-e are coupled to the water line 103 as it passes through the water blanket distributor 104i. When pressurized water flows from the water source and control components 102 into the water line 103, the water exits out of each of the nozzles 201a-e both from the horizontal nozzles 211a-e and the pop-up nozzles 212a-b.

FIG. 2d shows a top view of a single water blanket distributor 104j having a set of horizontal nozzles 202a-e along one side each of which has an output nozzle 221a-e. The water line 103 is shown passing through the single water blanket distributor 104j in which each of the horizontal nozzles 202a-e are connected to the water line 103 to operate as disclosed above.

FIG. 3 illustrates another example embodiment of a system for providing a wildfire home protection water blanket according to the present invention. The home protection water blanket system 100 of FIG. 3 shows the water source and control components 102 connected to an WIFI-enabled water valve 303 that connects the water source 112 to the water line 103 such that the water will flow to the water blanket distributors 104a-d when the WIFI-enabled water valve 303 is opened. As discussed above in reference to FIG. 1, the water source 112 may be connected to the electrically controlled water valve 303 by a water pressurizer-pump 302.

The WIFI-enabled water valve 303 comprises a water valve having an internal smart controller that communicates with the mobile application 121 on the user interface device 115. One example WIFI-enabled water valve 303 is a B-Hyve.com from Orbit Irrigation Products of Salt Lake City, Utah that communicates with a commercially available mobile application to operate the water flow through the valve 303. Other water flow controllers may be used that may be remotely controlled from a mobile application 121 on the user interface device 115.

The WIFI-enabled water valve 303 may be powered by a battery 311 that may remain charged from one or more sources of electrical power with a solar panel 312 providing a back-up power source when the home or building is without electrical power. The WIFI-enabled water valve 303 communicates with a WIFI router 310 available in the home or building 101 to allow a homeowner to control the WIFI-enabled water valve 303 from anywhere in which the mobile application 121 can communicate over the Internet 110. The user interface device 115 typically communicates with the router 310 by using cellular signal connections 3 1 9a-c to reach the Internet 110. When the user interface device 115 is present on the local WIFI network supported by the router 310, the user interface device 115 may communicate with the router 310 and the WIFI-enabled water valve 303 directly.

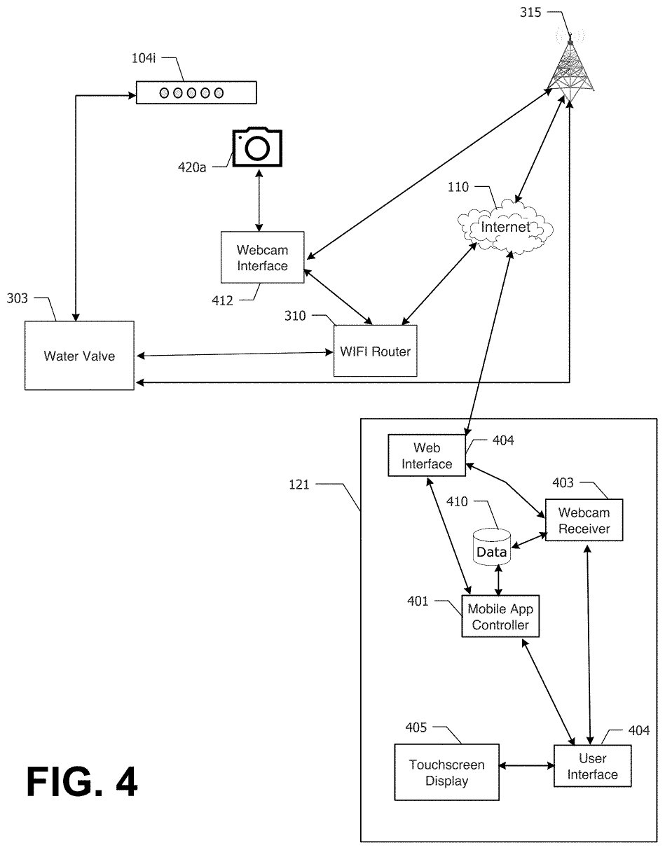

FIG. 4 illustrates a computing system of software components for providing a wildfire home protection water blanket according to the present invention. The user interface device 115 contains the mobile application 121 made up of a set of software components 401-405. The set of software components comprises a mobile app controller 401, a web interface 402, a webcam receiver 403, a user interface 404, a touchscreen device 405, and local data storage 410. These software components operate together to receive commands from the user and open and close the WIFI-enabled water valve 303. The mobile application 121 also contains the local data store 410 to retain data used to mobile application 121 and communicate with the WIFI-enabled water valve 303.

The mobile app controller 401 interacts with the other software components 402-405 to cause these software components to operate as commanded by a user of the user interface device 115. The mobile app controller 401 receives commands from the user via the touchscreen device 405 that are decoded and performed by the mobile application 121. The mobile app controller 401 sends and receives data from a user using the touchscreen display 405 via the user interface 404 to receive and respond to user commands. The mobile app controller 401 requests and obtains image data from connected webcams 420a-n and sends this received data to the user interface device 115. The mobile app controller 401 also may periodically request and obtain images from these webcams 420a-n that are stored onto the local data store 410. The mobile app controller 401 may retrieve stored images and present them to the user user on the touchscreen device 405 at a later point in time as requested by the user.

The mobile app controller 401 also responds to user commands to communicate with the WIFI-enabled water valve 303. Based upon the user command, the mobile app controller 401 may respond to the user command by opening and closing the WIFI-enabled water valve 303 until a subsequent user command is received.

The mobile app controller 401 also may respond to a user command to open the WIFI-enabled water valve 303 for a preconfigured length of time. In response to this particular user command, the mobile app controller 401 may utilize an internal timer to determine how much time has passed since the electrically controlled water valve 303 was opened. When the internal timer indicates that the preconfigured length of time has passed, mobile app controller 401 instructs the WIFI-enabled water valve 303 to close without receipt of a subsequent user command from the user interface device 115.

The web interface 402 permits the mobile application 121 to communicate with one or more remote WIFI-enabled water valves 303 over the Internet 110. The web interface 402 performs all of the data formatting, computer-to-computer communications, encryption processing, and all similar operations needed by the mobile application 121 to communicate with the remote devices.

The web cam receiver 403 connects the mobile app controller 401 to an external camera 420a-n to obtain still and video images about the home or building 101 for transmission to the user interface device 115. The webcam receiver 403 may communicate with a webcam interface 412 over the Internet 110. The external camera 420a-n and the webcam interface 412 are located about the home or building 101 and communicate with the mobile application 121 on the user interface device 115 over the Internet 110. The webcam interface 412 may be electrically coupled directly to a camera to capture these images. The web cam interface 412 also may be communicatively connected to other third-party image devices (not shown) to obtain this data. For example, web enabled cameras 420a-n and related imaging devices such as wireless imaging doorbells, security cameras, and other webcams 420a-n may be present in the area about the home or building 101. As such, the mobile application 121 may communicate with these webcams 420a-n to obtain images upon receipt of a user command sent from the user interface device 115.

This capture image command may be sent to the mobile app controller 401 from touchscreen device 405 via the user interface 404 that causes the mobile app controller 401 to instruct available webcams 420a-n via each of their corresponding webcam interfaces 412 to obtain still and/or video images for transmission to the mobile application 121 on the user interface device 115. The user also may directly communicate with these third-party webcams 420a-n using mobile applications associated with each such device to command the webcams to obtain these images and send them to the user interface device 115. Any of these images from the cameras and webcams may be viewed by the home or building owner to view conditions about the home or building 101 at any given time. The homeowner may use this image information to determine when to activate the home protection water blanket system 100.

The user interface 404 provides input and output processing to provide a homeowner with images, messages, and data needed to perform the water blanket 105 generation as needed. The user interface 404 also allows the homeowner to view images obtained from the various webcam devices 420a-n in order to conditions about the home or building 101. This interface module 404 also accepts commands from the homeowner to instruct the application to perform these tasks.

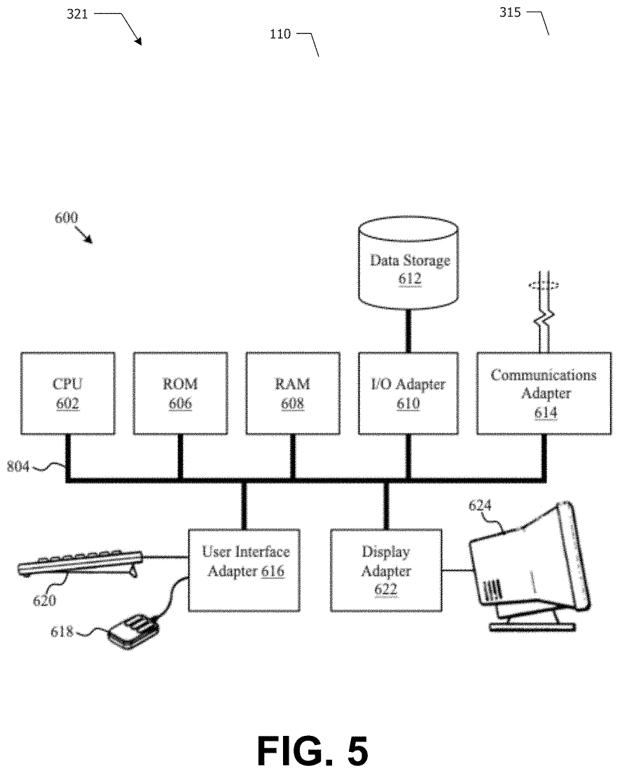

FIG. 5 illustrates a generalized schematic of a programmable processing system utilized as the various computing components described herein used to implement an embodiment of the present invention. Specifically, FIG. 5 illustrates a computer system 600 adapted according to certain embodiments of the user interface device 115 running the mobile application 121. A central processing unit (CPU) 602 is coupled to the system bus 604. The CPU 602 may be a general-purpose CPU or microprocessor, graphics processing unit (GPU), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 also may include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid-state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 608, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

The applications of the present disclosure are not limited to the architecture of a computer system 600. Rather the computer system 800 is provided as an example of one type of computing device that may be adapted to perform the functions of a controller 321 and/or the user interface device 115. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing a wildfire home protection water blanket, the system comprising:
a plurality of water blanket distributors attached to and integrated into the fascia of a building, the plurality of water blanket distributors comprise an enclosure attached to and integrated into the fascia of the building under the eaves, a plurality of water distribution nozzles and a water line;
a water source and control components for connecting the plurality of water blanket distributors to a water source, the water source and control components comprise a water valve and a WIFI-enabled controller; and;
the water line connecting the plurality of water blanket distributors to the water valve, the water line receives water from the water valve upon receiving a user command.

2. The system according to claim 1, wherein the water distribution nozzles comprise a horizontal nozzle applying the wildfire home protection water blanket to outside walls of the building under the eaves.

3. The system according to claim 2, wherein the water distribution nozzles further comprise a popup nozzle applying the wildfire home protection water blanket to a roof of the building.

4. The system according to claim 1, wherein the system further comprises a user interface device electronically connected to the water source and control components for transmitting the user command to open and close the water valve.

5. The system according to claim 4, wherein the water valve has a WIFI-enabled internal smart controller for receiving the user commands from the user interface device.

6. The system according to claim 1, wherein the plurality of water blanket distributors physically abuts each other as positioned about the building enclosing the water line therein.

7. The system according to claim 1, wherein the plurality of water blanket distributors are configures about all of the eaves and fascia of the building to direct the wildfire home protection water blanket onto all of the outside wall surfaces of the building.
